(19) United States
(12) Patent Application Publication
(10) Pub. No.: US 2007/0165237 A1
(43) Pub. Date: Jul. 19, 2007

(54) Fourier spectrometer with a modular mirror, integrated on

(76) Inventors: Dietmar Knipp, Bremen (DE); Helmut Stiebig, Niederzier (DE)

Correspondence Address: K.F. ROSS P.C., 5683 RIVERDALE AVENUE, SUITE 203 BOX 900, BRONX, NY, 10471-0900, US

(21) Appl. No.: 11/587,290

(22) PCT Filed: Apr. 20, 2005
(86) PCT No.: PCT/DE04/00725

§ 371 Date: Oct. 19, 2006

(30) Foreign Application Priority Data
Apr. 22, 2004 (DE) 10 2004 019 570.6

(51) Int. Cl. G01B 9/02; G01J 3/45

(52) U.S. Cl. 356/453

(57) ABSTRACT

The invention relates to a Fourier spectrometer (1), for determining spectral information of an incident optical input signal (2) and a method for producing such a Fourier spectrometer. The aim of said invention is to allow the accurate production of a small-sized and compact Fourier spectrometer, by means of which, in particular, both 1D and 2D spectrometer arrays may be produced. Said aim is achieved, whereby a Fourier spectrometer is provided, said spectrometer comprising a support layer (4) which is transparent to the optical input signal, a sensor (2), for producing an electrical output signal, which is placed on the support layer and is at least partially transparent to the optical input signal, a reflective layer (3), placed on the sensor side opposite to the support layer, for reflecting the incident optical input signal (2) and producing an optically standing wave from the incident input signal and reflected input signal as well as a cavity (7), located between the sensor and reflective layer, for allowing a modulation of the distance between the sensor and reflective layer, whereby said sensor is embodied for scanning the intensity of the standing wave and for producing an output signal, containing the spectral information of the input signal. The support layer, the sensor and the reflective layer are together integrated into a semiconductor component (1) and oriented substantially parallel to each other and perpendicular to the incident optical input signal, for the production of the optically standing wave.

The present invention relates to a Fourier spectrometer for determining the spectral information of an incident optical input signal as well as a method for the production of such a Fourier spectrometer.

Fourier spectrometers are for example of interest as far as applications in the fields of optical measuring technology, optical communication, object detection, biophotonic and material characterization. Fourier spectrometers are typically based on Michelson interferometers or variants of Michelson interferometers. With them, the incident light beam is separated into a measuring beam and a reference beam by a beam splitter. Subsequent to reflection at the measuring and reference mirror, the beams are superposed in the detector arm. The superposition of the two waves with the same propagation direction leads to the generation of a standing wave. Subsequently, the standing wave is detected by a semiconductor sensor. The two optical beam paths (measuring beam and reference beam) are perpendicular to each other if the interferometer/spectrometer is designed in that way. Due to the design, 1 D and 2 D spectrometer arrays cannot be made.

Different designs of Fourier spectrometers are known. In addition to a design by means of optical components, for example MEMS (Micro Electro Mechanical System) spectrometers based on Michelson interferometers are known that are produced by means of bulk silicon technology. The optical axis of the spectrometer is parallel to the substrate. Thus, it is also impossible to realize spectrometers as 1 D or 2 D array of spectrometers.

It is furthermore known to scan a standing wave by means of a semiconductor detector. A standing wave can be generated by superposition of two beams propagating in two opposite directions. Here, the incident light is reflected by an adjustable mirror. By the superposition of the beam running back and forth, a standing wave is formed in front of the mirror. The standing wave is scanned by a semitransparent sensor that is positioned in the standing wave. The sensor is sufficiently transparent to let a sufficient amount of light pass the sensor and a standing wave is generated in front of the adjustable mirror. At the same time, the transmission of the sensor must not be too high, in order that a sufficient amount of photons are absorbed in the semitransparent detector, so that a photocurrent can be generated by the detector.

By reducing the spectrometer construction to a semitransparent sensor and an adjustable mirror, the structure of an interferometer/spectrometer is reduced to a minimum.

These semitransparent semiconductor structures, however, have not been made, or have been only to a certain extent. The basic reason for this is the fact that the active section of the semitransparent sensor has to be significantly thinner than the wave length of the incident light. The basic requirement for scanning a standing wave is
d=λ/(4·n),
where d is the thickness of the active layer of the sensor, λ represents the wave length of the incident light, and n represents the refractive index. If the supposed refractive index is n=3.3 for silicon and the wavelength is less than 633 nm (e.g. of a HeNe laser), the layer thickness of the active section is 50 nm or less. When active semi-conductive layers in the range of <50 nm (if silicon is used) are produced for use on transparent substrates, such as e.g. glass, high requirements have to be met by the production technology. However, the conditions described before apply only to the active section of the detector and not to the total layer thickness of the detector. Correspondingly, the total layer thickness of the sensor may be increased, which significantly simplifies the production of the detector. Furthermore, the sensor also has to have sufficient transmission characteristics, so that a standing wave can be formed in front of the mirror.

These semitransparent sensors may be used as components of an interferometer or spectrometer. The requirements that have to be met by the sensor structure as part of a spectrometer, however, are significantly different compared to the requirements that have to be met by a sensor as part of an interferometer. The semitransparent sensors differ in that the sensor of the interferometer can be optimized for a fixed wavelength. Thus, for example losses due to reflections in transition areas between the layers may be reduced. In the case of a spectrometer, the component has to be optimized for a spectral region. Correspondingly, compromises have to be made as far as the design is concerned, as the component cannot be optimized in the same way for all wavelengths.

Furthermore, semitransparent sensors differ in a further aspect. The aim of the measurement with an interferometer is to determine changes in the position of the measurement mirror (determination of the relative difference) or to determine values derived therefrom. In order to determine the direction of the mirror's movement, a second semitransparent sensor is needed that also has to be set in the standing wave. Between the signals of the two sensors, there has to be a phase difference of 90°. The same conditions are also applied to a Michelson interferometer. Also, two detectors are used in order to determine the direction of the mirror's movement. In the case of a standing wave interferometer, this may be achieved by introducing the two semitransparent sensors extending a distance of 90 into the standing wave. In the case of a spectrometer, however, the use of a single semitransparent sensor is sufficient.

To date, the concept of scanning a standing wave by means of a semitransparent sensor and the application as interferometer are known. Furthermore, the concept of scanning a standing wave by means of a semitransparent sensor and the application thereof as Fourier spectrometer are known, for example from H. L. Kung et al, “Standing-wave transform spectrometer based on integrated MEMS mirror and thin-film detector”, IEEE Selected Topics in Quantum Electronics, 8, 98 (2002). The spectrometer described therein uses an amorphous/polycrystalline silicon detector that is used as semitransparent sensor. The sensor is based on photoconductor construction. The sensor is operated in combination with a separate MEMS-based mirror that may be adjusted electrostatically. Here, the mirror was made using bulk silicon technology. The mirror may be moved through 65 μm, so that a relative high tension of >100V has to be applied to the electrodes in order to move the mirror. The movement of the mirror is of significant importance for the resolution performance of the spectrometer. A larger movement range is advantageous, since this way the spectral resolution of the spectrometer may be improved. The spectrometer is limited by the temporal response of the photoconductor. Furthermore, the optical design of the detector is not adapted to the incident light, so that the photocurrent response of the sensor is not linear.

Furthermore, the operation of the spectrometer is further complicated by the fact that the detector and the adjustable mirror have to be arranged such that they face each other. The alignment of the mirror and the detector perpendicular to the optical axis and parallel to each other requires a lot of time and effort, as a slightly exaggerated tilting of the mirror and the detector in their orientation results in wrong measuring results.

D. Knipp et al, “Design and modeling of a Fourier spectrometer based on sampling a standing wave,” Proc. Mat. Res. Soc. Conference San Francisco, USA, Fall 2001, treats the design of the semitransparent sensor as part of a MEMS Fourier spectrometer. The sensor described therein, however, can also be used in a standing wave interferometer. The construction design or a possible integration with a detector in order to form a Fourier spectrometer are not treated.

The present invention is based on the object of providing a Fourier spectrometer that can be produced in smaller, more compact and more accurate ways and particularly that can also be produced as a 1 D and 2 D spectrometer. Furthermore, a suitable method for the production of such a Fourier spectrometer is to be provided.

This object is attained according to the invention by means of a Fourier spectrometer according to claim 1, including:

a support layer that is transparent to the optical input signal;

a sensor for the generation of an electrical output signal, that is provided on the support layer, and that is at least partially transparent to the optical input signal;

a reflective layer provided on the side of the sensor opposite the support layer for reflecting the incident optical input signal and for generating an optically standing wave from the incident input signal and the reflected input signal for reflecting the incident optical input signal and for the generation of an optical standing wave of the incident input signal and the reflected input signal, and

an empty chamber located between the sensor and the reflective layer for allowing adjustment of a spacing between the sensor and the reflective layer, the sensor being designed for scanning the intensity of the standing wave and for generating an output signal containing the spectral information of the input signal; and

wherein the support layer, the sensor and the reflective layer together are integrated in a semiconductor component and are substantially oriented parallel to each other and perpendicular to the incident optical input signal for the generation of the optical standing wave.

The spectrometer according to the invention thus requires no beam splitter and no reference mirror. The physical principle of the spectrometer is based on scanning an optically standing wave in front of a reflective layer, for example a measuring mirror. This way, the standing wave is generated exclusively by the superposition of the wave running forward and backward in front of the reflective layer. The standing wave is scanned by a semitransparent sensor (detector) that is introduced in the beam path. Thus, the structure of the spectrometer is reduced to a minimum. The spectrometer consists therefore of a linear arrangement of a reflective layer that can be adjusted and a semitransparent sensor. Both components are commonly integrated. Due to the linear arrangement of the spectrometer, they can be made as 1 D and 2 D spectrometer arrays. Spectrometer arrays are characterized in that they can determine both position information and spectral information. The spectral information is gained by Fourier transform of the measuring signal.

The spectrometer according to the invention thus requires no beam splitter and no reference mirror. The physical principle of the spectrometer is based on the scanning of an optically standing wave in front of a reflective layer, the spacing between the reflective layer and the sensor being adjustable. Thus, the construction proposed herein is completely different from the known Fourier spectrometers.

For the construction of a compact and cost-efficient spectrometer, the sensor and the reflective adjustable layer may be integrated together, which integration means the processing/generation of a common component consisting of a sensor and a reflective layer.

Preferably, the spectrometer according to the invention is an MEMS Fourier spectrometer. All components of the spectrometer are preferably produced by means of thin-film technology. Therefore, the spectrometer in this embodiment consists of a semitransparent thin-film sensor in combination with an adjustable mirror and is also produced by means of thin-film technology. Thus, both components can be easily integrated together. The spectral information is gained by Fourier transform of the sensor signal. The sensor signal herein corresponds to a photocurrent. The signal is generated by scanning the standing waves in front of the measuring mirror. Generally, either the measuring mirror and/or the semitransparent sensor can be adjusted, an electrostatic adjustment of the measuring mirror and/or of the semitransparent sensor being preferred.

According to the invention, the sensor and the reflective layer are provided on the same carrier (substrate). The optical axis of the spectrometer is oriented perpendicular to the substrate. Thus, production costs are reduced since the spectrometer can be tested during the production process.

Furthermore, 1 D and 2 D spectrometer arrays can thus be produced on one carrier (substrate). Compared to this, an MEMS spectrometer the optical axis of which runs parallel to the substrate, has to be diced (sawed) first, before the function of the spectrometer can be tested. Thus, production costs are increased.

In a preferred embodiment of the spectrometer according to the invention, layer electrodes for contacting the sensor and/or for applying an electric voltage for electrostatic modulation of the spacing between the sensor and the reflective layer are provided, the layer electrodes consisting of conductive oxides, particularly of Sn0₂, ZnO, In₂0₃ or Cd₂Sn0₄ doped with B, Al, In, Sn, Sb or F; of thin metal films, particularly of Al, Ag, Cr, Pd or of semiconductive layers particularly of amorphous, microcrystalline, polycrystalline or crystalline semiconductor layers of silicon, germanium, carbon, nitrogen, oxygen or alloys of these materials.

Preferred embodiments of the semitransparent sensor are furthermore described in claims 4 and 5. Accordingly, the semitransparent sensor can be designed as photoconductor, Schottky diode, pin-, nip-, pip-, nin-, npin-, pnip, -pinp-, nipn-structure or as a combination of such structures. Furthermore, it may be provided that the semitransparent sensor has at least one photoelectrically active semiconductor layer consisting of an amorphous, microcrystalline, polycrystalline or crystalline material, particularly of the materials silicon, germanium, carbon, nitrogen, oxygen and/or alloys of these materials. By using different semiconductive materials, the spectrometer may be adapted to a corresponding spectral region. Carbon and oxygen and the alloys with silicon can be used particularly in the ultraviolet and in the visible regions of the optical spectrum, silicon particularly in the visible region and germanium and its alloys with silicon particularly in the visible and in the infrared spectral regions.

According to a further embodiment, optical adaptation layers are preferably provided for the optical adaptation of the Fourier spectrometer. Here, these dielectric layers mainly have the object of adapting the sensor optically to the incident spectrum, so that the standing wave can penetrate the semitransparent sensor without meeting any obstacles and so that losses are minimized by means of reflection on the single layers of the semitransparent sensor.

The invention furthermore relates to a Fourier spectrometer array with several Fourier spectrometers of the above-described kind integrated on one single common carrier layer arranged in a line or in an grid. It is possible to form such a Fourier spectrometer array on one carrier layer only by means of the common integration of the sensors and of the reflective layer/reflective layers on one single carrier layer, by which also one or two dimensional position information can be detected in a simple way, in addition to the spectral information.

A method according to the invention for the production of a Fourier spectrometer of the kind according to the invention is described in claim 10. The method consists of the following steps:
deposition of an at least partially transparent sensor for the optical input signal on a carrier layer that is transparent to the optical input signals for the generation of an electrical output signal;
application of a sacrificial layer on the side opposite the sensor;
application of a reflective layer on the side opposite the sensor for the reflection of the incident optical input signal and for the generation of an optically standing wave from the incident input signal and the reflected input signal;
removal of the sacrificial layer to create an empty chamber between the sensor and the reflective layer in order to allow a modulation of the spacing between the sensor and the reflective layer, the sensor being designed for scanning the intensity of the standing wave and for the generation of an output signal containing the spectral information of the input signal; and
wherein the carrier layer, the sensor and the reflective layer are integrated together in a semiconductor component and basically are aligned parallel to each other and are perpendicular to the incident optically input signal for the generation of the optically standing wave.

Preferably, the sensor is produced by means of a deposition process, particularly by means of a CVD process, sputter process or epitaxy process. For the production of the reflective layer, thin-film technology and surface micromechanics are preferably used.

The invention is further explained in the following by means of the drawing.

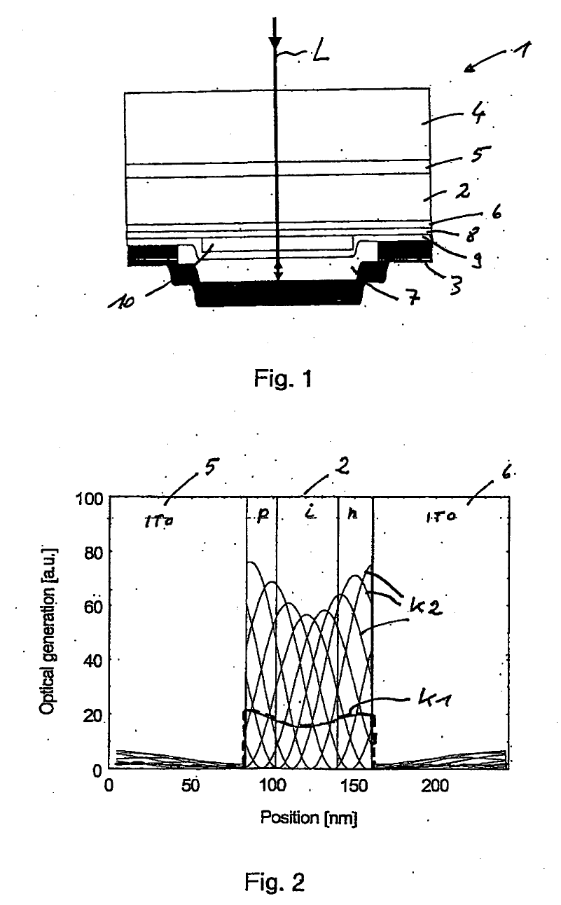

FIG. 1 shows a first embodiment of a Fourier spectrometer according to the invention;

FIG. 2 is a schematic representation of the optical generation rate (intensity) of the incident light for a transparent sensor as a function of the position of the adjustable mirror;

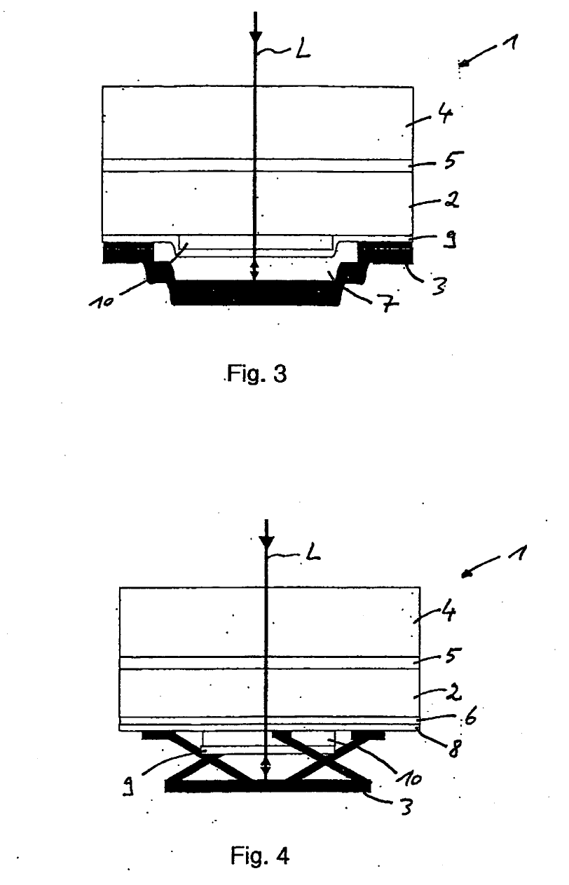

FIG. 3 shows a second embodiment of a Fourier spectrometer according to the invention

FIG. 4 shows a third embodiment of a Fourier spectrometer according to the invention in a side view;

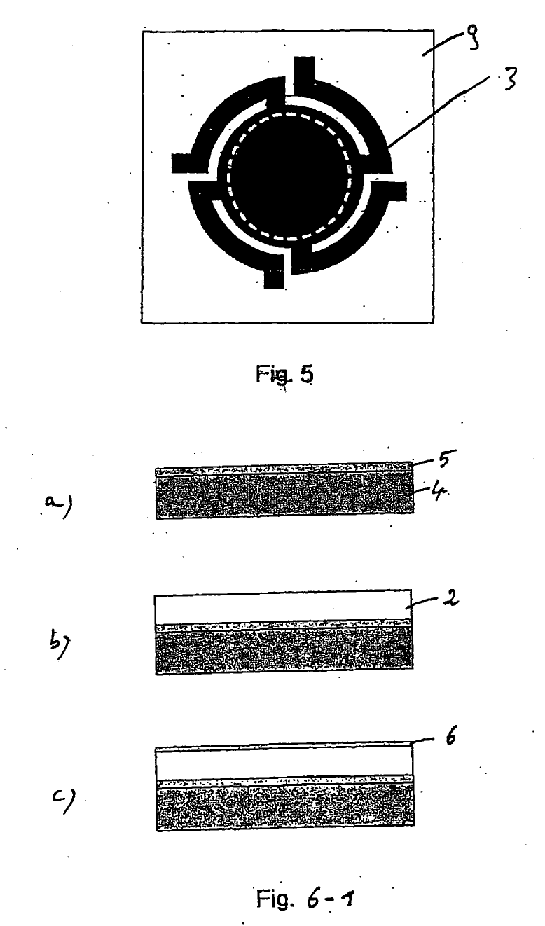

FIG. 5 shows a top view of the third embodiment of the Fourier spectrometer according to the invention; and

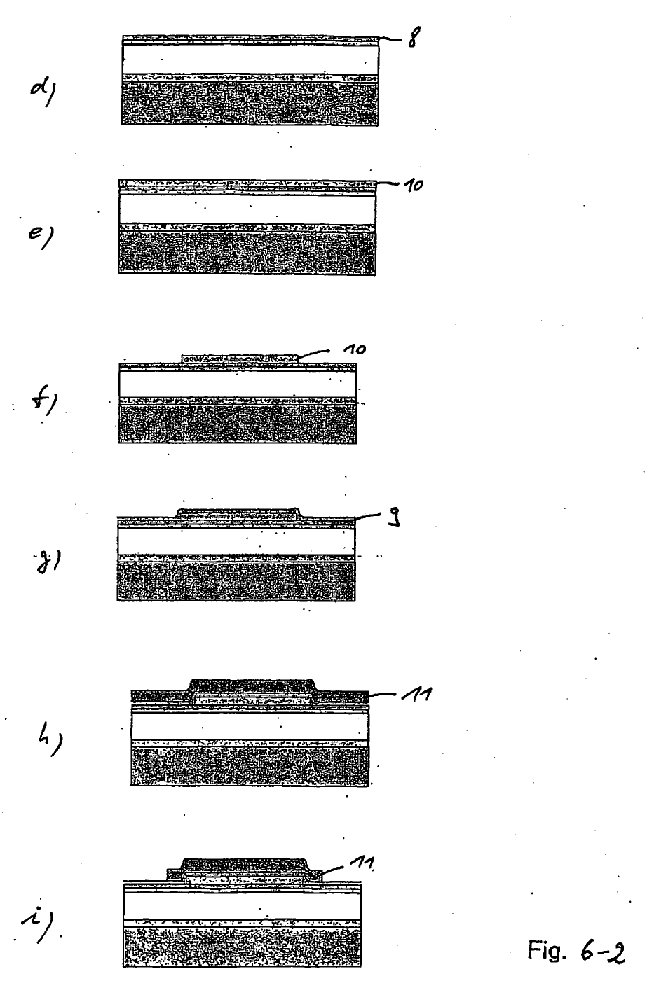

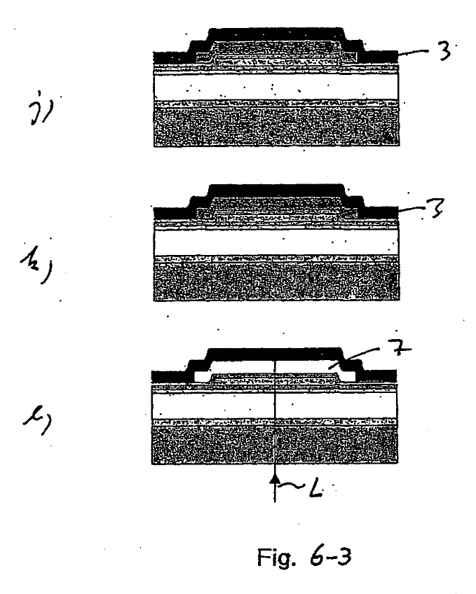

FIG. 6 shows the single process steps of the production method according to the invention for the production of the Fourier spectrometer according to the invention.

In FIG. 1, the schematic construction of an embodiment of a Fourier spectrometer 1 is shown. A sensor 2 and a reflective layer 3, particularly a mirror, are provided therein as parallel layers on a substrate 4. The semitransparent sensor 2 is contacted by two transparent, conductive electrodes 5 and 6. Between the sensor 2 and the mirror 3, an empty chamber 7 is formed allowing adjustment of a spacing between the sensor 2 and the mirror 3, particularly of the position of the mirror 3. Furthermore, between the electrode 6 and the empty chamber 7, two insulating layers 8 and 9 are arranged with an electrode 10 between them. Thus the reflective layer 3 and the electrode 6 form a condenser/capacitor arrangement.

By applying voltage to this arrangement, the reflective layer 3 can be electrostatically moved or adjusted. The insulating layer 8 serves for the electrical insulation of the semitransparent sensor 2 and of the adjustable mirror 3. Thanks to the insulating layer 9, direct electrical contact of the electrode 10 and the reflective layer 3 is avoided.

Light L, perpendicularly incident to the surface of the spectrometer 1 is partially (about 40-90%) transmitted by the sensor 2 and reflected by the adjustable mirror 3. Consequently, a standing wave is produced in front of the mirror 3. The mirror 3 can be positioned electrostatically. Thus, the standing wave can be modulated in front of the mirror 3 as a function of the voltage applied. Consequently, the sensor signal is adjusted. Alternatively, a construction may be chosen in which the sensor 2 is moved. In both cases, the sensor 2 and the mirror 3 do not have to be meticulously positioned and set relative to each other, since the mirror 3 is produced together with the semitransparent sensor 2.

The material used for the optical sensor 2, may for example be amorphous silicon. Other inorganic and organic materials that are optoelectrically active can also be used as sensor. The optical design of the semitransparent sensor 2 has to be adapted to the desired spectral region. Since the spectrometer 1 is supposed to cover a further spectral region, the sensor 2 can be provided with a particular antireflective layer/coating layer (not shown). As far as the sensor 2 is concerned, a pn- or pin-diode arrangement or a modified arranged may be used for this purpose. Besides, a Schottky diode arrangement or a photoconductor arrangement can be used. The two transparent conductive electrodes 5 and 6 are preferably made of ITO (indium tin oxide).

If direct or alternating voltage is applied to the adjustable mirror, the standing waves shift in front of the mirror. The standing waves are shifted through the semitransparent sensor due to the adjustment of the mirror. The modification of the optical generation within a semitransparent sensor as function of the mirror's position is schematically shown in FIG. 2 for a wavelength of 550 nm. The maximum and the minimum of the standing wave are pushed through the semitransparent sensor. In that case, a sensor structure consisting of an amorphous pin-diode that is provided with two contact layers of ITO (indium tin oxide) was provided. The dotted curve K1 shows the course of the optical generation without the mirror. The curves K2 shown with solid lines correspond to the optical generation using the mirror. The mirror was moved 20 μm in the calculations. It is clearly visible how the minima and maxima are shifted through the semitransparent sensor.

The adjustable mirror 3 is also preferably produced by means of thin-film technology. To this end, the empty chamber 7 is formed by the removal of a sacrificial layer consisting for example of amorphous silicon or a metal. The sacrificial layer is removed by wet-chemical or dry etching. In the embodiment of the mirror 3 shown in FIG. 1, the mirror was made right on the semitransparent sensor 2. The membrane of the mirror 3 can be electrostatically adjusted. A further transparent conductive electrode 10 that is used as a front electrode of the mirror 3 was applied to the sensor.

The structured back electrode 6 of the sensor 2, however, can also be used as common electrode for the sensor 2 and the mirror 3. In FIG. 3, the schematic construction of such an embodiment of the Fourier spectrometer according to the invention is shown. The construction of this embodiment is simplified compared to the construction of the embodiment shown in FIG. 1. No passivation layer/insulating layer 8 and no transparent conductive layer 6 were used. The membrane of the mirror 3 is identical in both cases. In both cases, the metal layer 3 with high reflective characteristics is applied to the passivation layer 9 (FIG. 1) and the sacrificial layer (not shown in FIGS. 1 and 3, but shown as empty chamber 7). Materials such as silver, aluminum, chrome or gold may be preferably used for that purpose.

Typically, such a layer is sputtered onto the existing layer stack. To do this, roughness of the metal film and high reflection of the material applied are of importance. The surface of the metal layer (transition empty chamber 7 and reflective layer 3 in FIGS. 1 and 2) should be as smooth as possible. Subsequently, an electroplating process is typically used in order to apply a further metal layer. This step is not shown in FIGS. 1 and 3. The reflective layer 3 may consist of one or more layers, according to the embodiment. Thus the layers used may consist of one or of several metals. Due to the mechanical requirements with regard to the reflective layer, several layers are applied. Since the reflective layer is a supporting layer, an appropriate layer thickness is required. Typically, layers that are thicker than 10 μm are used for this purpose. However, considerable efforts regarding time and resources are required in order to apply these thick layers by means of a sputter process. Hence, two processes are used. A first thin layer is sputtered on. Subsequently, the rest of the layer is applied by means of an electroplating process. The electroplating process is characterized in that significantly thicker layers can be applied in shorter times.

In addition to the possible use of a metal layer or a multilayer system of metal, the mirror can also be made by means of an only partially transparent layer. In that case, it is necessary that a certain amount of light be reflected by this layer, so that a standing wave can be formed. Advantageously, in such an assembly the spectrometer can be operated in transmission mode. Thus, a Fourier spectrometer can be introduced into the path of a beam without beam splitters having to be used that decouple a part of the beam and direct it onto a spectrometer. This is of particular interest in the field of optical telecommunication.

Amorphous silicon may be used as a possible sacrificial layer. The material can be deposited in a chemical vapor deposition (CVD) or sputter process. After the application of the reflective layer, holes are formed in the reflective layer (the metal layer is removed at certain points) and the sacrificial layer is removed by a wet chemical or by means of a dry etching process, for example by means of xenon difluoride.

In order to achieve a spectral resolution of the spectrometer that is as high as possible, the mirror should preferably be capable of being moved over a further region. In the embodiments shown in FIGS. 1 and 3, the movement of the mirror is limited by the thickness of the sacrificial layer in addition to the design of the mirror. Alternatively, other mirror designs may be used. For example, mechanical stress in metal films may be used. Such an embodiment is shown in FIG. 4 in side view and in FIG. 5 in top view. There, multimetal layers are applied that are strongly braced. After the removal of the sacrificial layer, the metal film yields to the stress in the film. The metal film has characteristics that are similar to a spring. The spring constant can be adjusted by means of the deposition conditions and the layer thicknesses of the metal films. This effect, which can be controlled very accurately, can be used for increasing the spacing between the mirror and the sensor. This was shown in an impressing way by examinations of mirror arrays. The mirror is thus appended by means of “springs.”

By means of FIG. 6, an example of the production process for the production of an integrated Fourier spectrometer as shown in FIG. 1 is shown. The single production steps are briefly explained in the following:

a) Deposition of a first transparent front electrode 5, e.g. made of ITO, on the substrate 2.

b) Deposition of the semitransparent sensor 2. The sensor 2 may consist of a pn-, np-, pin-, nip-, pnip-, pinp, nipn-, npin-diode, a combination of the arrangements, a Schottky diode arrangement or a photoconductor arrangement.

c) Deposition of a second transparent back electrode 6, e.g. made of ITO.

d) Application of a passivation layer 8 between the semitransparent sensor 2 and the adjustable mirror. The passivation layer 8 may be a plasma-enhanced chemical vapor deposition (PECVD) silicon layer that is transparent to the incident light thanks to its large optical band gap. Alternative materials such as silicon oxide or aluminum oxide may also be used.

e) Application of a fixed transparent electrode 10 for the MEMS based adjustable mirror. The material of the electrode 10 may consist of ITO.

f) Texturing of the fixed electrode 10 of the mirror.

Thus, parasitic capacities between the moveable electrode 3 and the fixed electrode 10 are reduced.

g) Application of a passivation 9 between the fixed and the moveable electrode 3 of the adjustable mirror.

h) Application of a sacrificial layer 11, e.g. made of amorphous silicon.

i) Texturing of the sacrificial layer 11.

j) Application of a reflective layer 3. The preferred materials to be used here are gold or silver. The layer can be applied by means of vaporization, electron beam vaporization, or as a sputter layer. Application of a further metal layer to the mirror surface. The layer may be applied by means of electroplating. The object to be achieved herein is the generation of a layer of several micrometers in order to mechanically stiffen the mirror 3.

k) Forming holes in the reflective layer (membrane of the mirror).

l) Removal of the sacrificial layer 11; in the case of amorphous silicon for example by means of xenon difluoride for the formation of the empty chamber 7. In case of xenon difluoride, a dry etching process is used. Alternatively, wet-chemical etching processes may be used.

The production process shown is by way of example. Both the production of the semitransparent sensor and the fabrication of the mirror can be modified. Furthermore, the production sequence of the construction elements can be modified. Possible alternative designs for the construction component are briefly described in the following.

The production of the Fourier spectrometer on a substrate that is transparent to the incident light is preferably carried out according to the following steps:

A 1 Production of the semitransparent sensor and the adjustable mirror on one side of the substrate.

A 1.1 The sensor is applied first, the mirror second. The mirror is modulated. Light is irradiated through the substrate.

A 1.2 The mirror is produced first. Subsequently, the sensor is applied. In that case, the mirror works only as reflector. The sensor signal is modulated. In that case, the light is not irradiated through the substrate.

A 2 Production of the semitransparent sensor and the adjustable mirror on both sides of the substrate.

A 2.1 The sensor is first applied on one side and subsequently, the mirror is applied on the other side. The mirror is adjusted. Light passes through the semitransparent sensor, subsequently through the substrate and is then reflected at the mirror.

A 2.2 The mirror is first produced on one side. Subsequently, the sensor is applied on the other side. In that case, the mirror works only as a reflector. The sensor signal is modulated. Light passes first through the semitransparent sensor, subsequently through the substrate and is then reflected at the mirror.

The production of the Fourier spectrometer on a substrate that is transparent to the incident light is preferably carried out according to the following steps:

B 1 Production of the semitransparent sensor and the adjustable mirror on one side of the substrate.

B 1.1 The sensor is applied first, the mirror second. The mirror is modulated. Light is irradiated through the substrate.

B 1.2 The mirror is produced first. Subsequently, the sensor is applied. In that case, the mirror works only as reflector. The sensor is adjusted. In that case, the light is not irradiated through the substrate.

The application of the sensor and of the mirror on different sides of the substrate is advantageous with regard to the contacting the components.

On the other hand, the beam widens when it penetrates the substrate, which is an undesired effect. Furthermore, it is unknown whether the optical coherence of the incident light is sufficient to form a standing wave. Thus, compromises have to be made.

Similar effects are observed as far as the variant in which the sensor is adjusted instead of the mirror is concerned. In that case, the mirror is stationary. That embodiment is advantageous since the incident beam does not have to penetrate the substrate. Reflections at the substrate's areas of transition to the air or to the layers of the semitransparent sensor negatively influence the propagation of a standing wave in the sensor. In that case, however, the modulated sensor has to be connected to the readout electronics. This causes significantly more effort than the use of an adjusted mirror.

According to the invention, the problems of the known MEMS Fourier spectrometer can be avoided by integrating the semitransparent sensor together with the adjustable mirror. Thus, the number of components is reduced and the orientation process of sensor and mirror towards each other is avoided. Thin-film technology is the preferred technology. Thus, the spectrometer can be made on a neutral substrate such as glass. The use of a neutral substrate leads to a reduction of the production costs. Furthermore, by using thin-film technology an adjustable mirror that can be moved over a larger area, even with small operational voltages, may be produced.

1. A Fourier spectrometer for determining spectral information of an incident optical input signal, the spectrometer comprising:
a support layer that is transparent to the optical input signal;
a sensor for the generation of an electrical output signal, that is provided on the support layer, and that is at least partially transparent to the optical input signal;
a reflective layer provided on a side of the sensor that is opposite to the support layer for reflecting the incident optical input signal and for generating an optically standing wave from the incident input signal and the reflected input signal for reflecting the incident optical input signal and for the generation of an optical standing wave of the incident input signal and the reflected input signal; and
an empty chamber between the sensor and the reflective layer for allowing adjustment of a spacing between the sensor and the reflective layer, the sensor being designed for scanning the intensity of the standing wave and for generating an output signal containing the spectral information of the input signal; and
layer electrodes for contacting the sensor and/or for applying an electric voltage for the electrostatic adjustment of a spacing between the sensor and the reflective layer
wherein the layer electrodes consist of transparent, conductive oxides, particularly Sn0₂, ZnO, In₂0₃ or Cd₂Sn0₄ doped with B, Al, In, Sn, Sb or F: of thin metal films, particularly of Al, Ag, Cr. Pd or of semiconductive layers particularly of amorphous, microcrystalline, polycrystalline or crystalline semiconductor layers of silicon, germanium, carbon, nitrogen, oxygen or alloys of these materials;
wherein the support layer, the sensor and the reflective layer together are integrated in a semiconductor component and are substantially oriented parallel each other and perpendicular to an incident optical input signal for the generation of the optically standing wave.

2. The Fourier spectrometer according to claim 1, further comprising adjusting means for adjusting the spacing between the sensor and the reflective layer, particularly by applying an electrical voltage for the electrostatic adjustment of the position of the sensor and/or of the reflective layer as function of the voltage applied.

3. (canceled)

4. The Fourier spectrometer according to claim 1 wherein the semitransparent sensor is designed as photoconductor, as Schottky diode, pin-, nip-, pip-, nin-, npin-, pnip, -pinp-, nipn-structure or as combination of such structures.

5. The Fourier spectrometer according to claim 1 wherein the semitransparent sensor has at least one photoelectric active semiconductor layer that is formed of an amorphous, microcrystalline, polycrystalline, or crystalline material, particularly of materials such as silicon, germanium, carbon, nitrogen, oxygen and/or alloys of these materials.

6. The Fourier spectrometer according to claim 1, further comprising optical adaptation layers for the optical adaptation of the Fourier spectrometer.

7. A Fourier spectrometer array with several Fourier spectrometers according to claim 1 wherein the array is integrated on one single, common carrier layer, arranged in one line or in an array.

8. A method for the production of a Fourier spectrometer according to claim 1 for determining the spectral information of an incident optical input signal, the method comprising the following steps:
deposition of an at least partially transparent sensor for the optical input signal on a carrier layer that is transparent to the optical input signals for the generation of an electrical output signal;
application of a sacrificial layer on a side opposite the sensor;
application of a reflective layer on the side opposite the sensor for the reflection of the incident optical input signal and for the generation of an optically standing wave from the incident input signal and the reflected input signal;
removal of the sacrificial layer for the generation of an empty chamber between the sensor and the reflective layer in order to allow changing of the spacing between the sensor and the reflective layer;
wherein the sensor is designed for scanning the intensity of the standing wave and for the generation of an output signal containing the spectral information of the input signal and wherein the carrier layer, the sensor and the reflective layer are integrated together in a semiconductor component and basically are aligned parallel to each other and are perpendicular to the incident optical input signal for the generation of the optically standing wave.

9. The method according to claim 8 wherein the sensor has to be specifically produced by means of a separating technique, particularly by means of a CVD-process, sputter process or epitaxy process.

10. The method according to claim 8 to wherein the reflective layer is produced by means of thin-film technology and surface micromechanics.
